(19) United States
(12) Patent Application Publication
(10) Pub. No.: US 2025/0342215 A1
(43) Pub. Date: Nov. 6, 2025

(54) CONTENT SEARCH METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventors: Dongliang LIAO, Shenzhen (CN); Minyi ZHAO, Shenzhen (CN); Shuigeng ZHOU, Shenzhen (CN); Yiru WANG, Shenzhen (CN)

(21) Appl. No.: 19/268,844

(22) Filed: Jul. 14, 2025

Related U.S. Application Data
(63) Continuation of application No. PCT/CN2024/093925, filed on May 17, 2024.

(30) Foreign Application Priority Data
Jul. 13, 2023 (CN) 202310858808.2

(51) Int. Cl. G06F 16/953

(52) U.S. Cl. CPC G06F 16/953

(57) ABSTRACT

A content search method performed by a computer device includes: obtaining search information and a media resource including a plurality of pieces of media content; extracting a text feature from the search information and a content feature from each of the plurality pieces of media content; transforming the plurality of content features to multiple mapped features, wherein a distance between a pair of mapped features represents semantic relevance between the pair of mapped features; performing semantic recognition on the mapped features based on the text feature, to determine semantic types corresponding to the mapped features; grouping the mapped features corresponding to the same semantic type into a same combination, and determining target mapped features meeting a relevance condition from different combinations based on the distances between mapped features in the different combinations; and determining search results for the search information from the media resource according to the target mapped features.

### CROSS-REFERENCE TO RELATED APPLICATIONS

This application is a continuation application of PCT Patent Application No. PCT/CN2024/093925, entitled “VIRTUAL ITEM EQUIPPING METHOD AND APPARATUS FOR, DEVICE, STORAGE MEDIUM, AND PROGRAM PRODUCT” filed on May 17, 2024, which claims priority to Chinese Patent Application No. 2023108588082, entitled “CONTENT SEARCH METHOD AND APPARATUS, ELECTRONIC DEVICE, STORAGE MEDIUM, AND PROGRAM PRODUCT” filed on Jul. 13, 2023, both of which are incorporated herein by reference in their entirety.

### FIELD OF THE TECHNOLOGY

This application relates to the field of computer technologies, and specifically, to a content search method and apparatus, an electronic device, a storage medium, and a program product.

### BACKGROUND OF THE DISCLOSURE

With the continuous development of Internet technology, information on the Internet has become increasingly rich. Users can search for content they need on the Internet through electronic devices such as mobile phones or computers. In actual search processes, users often need to browse through a large number of search results to find content that meets their needs. In the conventional technology, to meet search needs of users, several ranked-top search results are usually directly returned according to the similarity between search information and a content feature.

However, in actual application, search intents of users are diverse, and existing search methods are usually only suitable for search tasks with clear objectives and cannot provide users with accurate and diverse search results.

### SUMMARY

Embodiments of this application provide a content search method and apparatus, an electronic device, a storage medium, and a program product.

An embodiment of this application provides a content search method performed by a computer device. The method includes:
obtaining search information and a media resource, the media resource including a plurality of pieces of media content;
extracting a text feature from the search information and a content feature from each of the plurality pieces of media content;
transforming the plurality of content features to multiple mapped features, wherein a distance between a pair of mapped features represents semantic relevance between the pair of mapped features;
performing semantic recognition on the mapped features based on the text feature, to determine semantic types corresponding to the mapped features;
grouping the mapped features corresponding to the same semantic type into a same combination;
determining target mapped features meeting a relevance condition from different combinations based on the distances between mapped features in the different combinations; and
determining search results for the search information from the media resource according to the target mapped features.

An embodiment of this application further provides a computer device that includes a processor and a memory, the memory having a plurality of instructions stored therein; and the processor, by executing the instructions from the memory, causing the computer device to perform the operations in any content search method according to the embodiments of this application.

An embodiment of this application further provides a non-transitory computer-readable storage medium. The computer-readable storage medium has a plurality of instructions stored therein, the instructions, when executed by a processor of a computer device, causing the computer device to perform the operations in any content search method according to the embodiments of this application.

Details of one or more embodiments of this application are provided in the accompanying drawings and description below. Other features, objectives, and advantages of this application become apparent in the description of embodiments, accompanying drawings, and claims.

### BRIEF DESCRIPTION OF THE DRAWINGS

To describe technical solutions in embodiments of this application or the conventional technology more clearly, the following briefly describes accompanying drawings required for describing the embodiments or the conventional technology. Apparently the accompanying drawings in the following descriptions show merely the embodiments of this application, and a person of ordinary skill in the art may derive other drawings from these accompanying drawings without creative efforts.

FIG. 1 is a schematic diagram of a scenario of a content search method according to an embodiment of this application.

FIG. 2 is a schematic flowchart of a content search method according to an embodiment of this application.

FIG. 3 is a schematic diagram of feature distribution before and after mapping according to an embodiment of this application.

FIG. 4 is a schematic diagram of determining target mapped features according to an embodiment of this application.

FIG. 5 is a schematic flowchart of a content search method according to another embodiment of this application.

FIG. 6 is a schematic diagram of a video search interface according to an embodiment of this application.

FIG. 7 is a schematic structural diagram of a content search model according to an embodiment of this application.

FIG. 8 is a schematic diagram of a mapping effect of a semantic contrastive learning module according to an embodiment of this application.

FIG. 9 is a schematic diagram of a display page for search results according to an embodiment of this application.

FIG. 10 is a schematic structural diagram of a content search apparatus according to an embodiment of this application.

FIG. 11 is a schematic structural diagram of an electronic device according to an embodiment of this application.

### DESCRIPTION OF EMBODIMENTS

The following clearly and completely describes technical solutions in embodiments of this application with reference to accompanying drawings in the embodiments of this application. Apparently, the embodiments to be described are merely some rather than all of embodiments of this application. All other embodiments obtained by a person of ordinary skill in the art based on the embodiments of this application without creative efforts shall fall within the protection scope of this application.

The embodiments of this application provide a content search method and apparatus, an electronic device, a storage medium, and a program product.

The content search apparatus may be specifically integrated into an electronic device, and the electronic device may be a device such as a terminal or a server. The terminal may be a device such as a mobile phone, a tablet computer, a smart Bluetooth device, a notebook computer, or a personal computer (PC). The server may be a single server, or may be a server cluster including a plurality of servers.

In some embodiments, the content search apparatus may alternatively be integrated into a plurality of electronic devices. For example, the content search apparatus may be integrated into a plurality of servers, and the plurality of servers implement the content search method of this application.

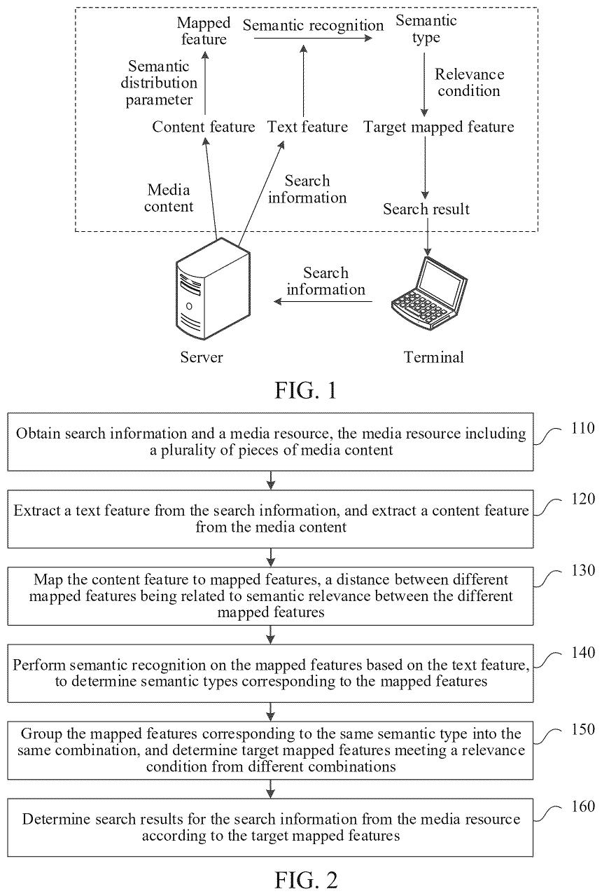

For example, referring to FIG. 1, the content search method is implemented by a server. The server may obtain search information provided by an application running on a terminal, and obtain a media resource, the media resource including a plurality of pieces of media content; extract a text feature from the search information, and extract a content feature from the media content; map the content feature to mapped features, a distance between different mapped features being related to semantic relevance between the different mapped features; perform semantic recognition on the mapped features based on the text feature, to determine semantic types corresponding to the mapped features; group the mapped features corresponding to the same semantic type into the same combination, and determine target mapped features meeting a relevance condition from different combinations; and determine search results for the search information from the media resource according to the target mapped features.

Detailed descriptions are provided below respectively. The order of the following embodiments is not intended to limit the preference order of the embodiments. In a specific implementation of this application, user-related data a such as search information, media content, timestamp, and popularity is involved. When the embodiments of this application are applied to specific products or technologies, user permission or consent is required, and collection, use, and processing of relevant data need to comply with relevant laws, regulations, and standards of relevant countries and regions.

Artificial intelligence (AI) is a technology that uses a digital computer to simulate humans to perceive an environment, obtain knowledge, and use the knowledge. The technology can enable machines to have perception, reasoning, and decision-making capabilities similar to those of humans. A basic artificial intelligence technology generally includes technologies such as a sensor, a dedicated artificial intelligence chip, cloud computing, distributed storage, a big data processing technology, an operating/interaction system, and electromechanical integration. An artificial intelligence software technology mainly includes major directions such as a computer vision technology, a speech processing technology, a natural language processing technology, machine learning/deep learning, autonomous driving, and intelligent traffic.

Computer vision (CV) is a technology in which a computer replaces human eyes to perform operations such as recognition and measurement on a target image and further performs processing. The computer vision technology generally includes technologies such as image processing, image recognition, image semantic understanding, image retrieval, virtual reality, augmented reality, synchronous positioning and map construction, autonomous driving, and intelligent traffic, and further includes common biometric feature recognition technologies such as facial recognition and fingerprint recognition, for example, image processing technologies such as image coloration and image stroke extraction.

Nature language processing (NLP) is an important direction in the fields of computer science and artificial intelligence. The nature language processing studies various theories and methods that enable efficient communication between humans and computers in a natural language. The natural language processing is a comprehensive science of linguistics, computer science, and mathematics. Therefore, research in this field relates to natural languages, that is, languages daily used by people, and therefore, the natural language processing is closely related to linguistic research. The natural language processing technology generally includes technologies such as text processing, semantic understanding, machine translation, robotic question answering, knowledge graph, and the like.

Machine learning (ML) is a multi-field interdiscipline that relates to a plurality of disciplines such as the probability theory, statistics, the approximation theory, convex analysis, and the algorithm complexity theory. The machine learning specializes in studying how a computer simulates or implements a human learning behavior to obtain new knowledge or skills, and reorganize an existing knowledge structure, to keep improving performance thereof. The machine learning is the core of AI, is a basic way to make the computer intelligent, and is applied to various fields of AI. The machine learning and deep learning generally include technologies such as an artificial neural network, a belief network, reinforcement learning, transfer learning, inductive learning, and learning from demonstration.

The automated driving technology usually includes high-definition maps, environment sensing, behavioral decision-making, route planning, motion control, and other technologies. The automated driving technology has a wide range of application prospects.

With research and advancement of the artificial intelligence technology, the artificial intelligence technology is researched and applied in a plurality of fields, such as common smart homes, smart wearing devices, virtual assistants, smart speakers, smart marketing, unmanned driving, autonomous driving, drones, robots, smart medicine, smart customer services, Internet of Vehicles, autonomous driving, or intelligent transportation. As the technology develops, the artificial intelligence technology will be applied in more fields, and play an increasingly important role.

In this embodiment, a content search method involving artificial intelligence is provided. As shown in FIG. 2, the content search method may include the following operations:

Operation 110: Obtain search information and a media resource, the media resource including a plurality of pieces of media content.

The search information is information configured for searching for relevant media content. In different application scenarios, the search information may be presented in different expression forms. For example, the search information may be a combination of one or more media forms, including, but not limited to, a text, a sound, an image, or a symbol.

The media content refers to content including at least one of media elements such as a text, an image, a sound, and a video. In different application scenarios, the media content may have different expression forms. For example, the media content may be a combination of one or more media forms.

The media resource refers to resource information obtained by aggregating a plurality of media content. For example, the media resource may be in a form of a database of an application. In actual application, the plurality of pieces of media content may be aggregated to form a media database, which is stored in a digital form on a computer, and integrated with the application, to be invoked and used by the application. The application may be a search application, an entertainment application, a shopping application, or the like.

For the search information in different expression forms and the media content in different expression forms, this embodiment of this application may be applied to a plurality of different application scenarios such as text-to-text search, text-to-image search, text-to-video search, image-to-image search, image-to-video search, image-to-text search, and video-to-video search, or may be applied to application scenarios of hybrid search. For example, in an application scenario of text-to-text search, the search information is a text, and the media content is an article. For another example, in an application scenario of hybrid search, the search information may be a text, the media resource includes media content of different types such as a text, audio, a sound, and a video, and/or the media resource includes media content of a combination of media elements such as a text, audio, a sound, and a video.

For example, in actual application, a server may obtain search information entered by a user on an application client. Specifically, after the application client detects the search information entered by the user, such as text content A, the client may send the text content A to the server. Simultaneously, the server invokes the media database to obtain the media resource. The media resource includes the plurality of pieces of media content such as media content 1 to 5.

Operation 120: Extract a text feature from the search information, and extract a content feature from the media content.

The text feature refers to a text-related feature extracted from the search information, and is configured for representing an attribute and a characteristic of the text. The attribute is an inherent property of the text in the search information, and the characteristic is a specific property of the text in the search information in a current scenario.

Usually, the text feature is a feature quantity extracted from the text contained in the search information, but may alternatively be a feature quantity extracted from other texts, such as a keyword, a tag, or a descriptive text, carried in the search information.

The content feature refers to a content-related feature quantity extracted from the media content, and may be configured for representing an attribute and a characteristic of the media content. The attribute is an inherent property of the media content, and the characteristic is a specific property of the media content in a current scenario.

For example, the server may extract a text feature 1 from the text content A entered by the user. In addition, the server may respectively extract content features 1 to 5 from the media content 1 to 5 in the media resource.

In some implementations, the search information includes content in a text form (that is, text content) and/or content in a non-text form (that is, non-text content). In this way, the text feature may be extracted from the text content related to the search information.

For example, when the search information includes a text, the text is directly used as text content. When the search information includes non-text content, text content may be extracted from the non-text content or text content may be obtained from information related to the non-text content. For example, when the search information includes audio information, a speech text is recognized from the audio information as text content. When the search information includes an image or a video, text content may be extracted from the image or the video, or a text such as a tag carried in the image or the video is used as text content.

In actual application, the text feature and the content feature may be extracted in a plurality of manners, and are represented numerically as vectors or matrices for ease of analysis and calculation. For example, corresponding text features may be respectively extracted from the text content and the media content of the search information by using one or a combination of neural network models such as a convolutional neural network (CNN), a recurrent neural network (RNN), a deep neural network (DNN), and an attention mechanism (Attention) network.

In some implementations, for ease of extraction of the text feature and the content feature, a pre-trained text encoder matching the text content may be used to extract the text feature, and a pre-trained content encoder matching the expression form of the media content may be used to extract the content feature. Specifically, the extracting a text feature from the search information, and extracting a content feature from the media content includes: obtaining a pre-trained neural network model, the pre-trained neural network model including a text encoder and a content encoder, and the pre-trained neural network model being obtained by training search information samples and media content samples; extracting the text feature from the search information by using the text encoder; and extracting the content feature from the media content by using the content encoder.

The search information samples refer to data samples formed by the search information. The media content samples refer to data samples formed by the media content.

For example, search information samples and media content samples of the same category may be constructed as positive samples, and/or search information samples and media content samples of different categories may be constructed as negative samples. The text feature and the content feature of the text content and the media content in the positive samples and/or the negative samples are extracted through a jointly pre-trained neural network model for the text content and the media content. The text feature and the content feature are extracted by the pre-trained neural network model obtained through joint training on the search information samples and the media content samples. For extraction of different features, especially, feature extraction of different types of data, for example, feature extraction of two types of a text and an image, there are differences between feature extraction methods and feature representation methods for different types of data. Through the joint pre-training process of the model with the search information samples and the media content samples, feature representation can affect and balance each other, thereby implementing correlation modeling between different types of data. This enables the trained neural network model to effectively and accurately extract features of different types of associated data.

In some implementations, a visual branch such as ViT (Vision Transformer) in a contrastive language-image pre-training model (for example, CLIP) may be used as a pre-trained text encoder. When the media content is an image, a natural language branch such as a bidirectional encoder (BERT) in the contrastive language-image pre-training model (CLIP) is used as a pre-trained content encoder. In a training process of the contrastive language-image pre-training model, the model is jointly trained by using a text and an image to jointly learn representations of the text and the image by using the visual branch and the natural language branch, thereby implementing correlation modeling between the text and the image. This enables the trained model to better extract the text feature and the content feature in an application scenario of a text-image joint task.

Operation 130: Map the content feature to mapped features, a distance between different mapped features being related to semantic relevance between the different mapped features.

The semantic relevance between the different mapped features represents whether semantics expressed by the different mapped features are related to each other, and may further represent a semantic relevance degree between the different mapped features when the different mapped features are related to each other.

The distance between the different mapped features in a feature space of the mapped features is related to the semantic relevance between the different mapped features. For the distance between the different mapped features, a distance when the different mapped features are semantically related is less than a distance when the different mapped features are semantically unrelated. In addition, in some embodiments, the distance is negatively correlated with the semantic relevance degree.

In some embodiments, the semantically related content features have a smaller distance after mapping, while the semantically unrelated content features have a larger distance. In this case, the semantically related mapped features exhibit clustering.

In some embodiments, an electronic device may map the content feature according to preset feature semantic distribution parameters, to obtain the mapped features, distribution of the mapped features following a distribution pattern corresponding to the feature semantic distribution parameters. The feature semantic distribution parameters are parameters configured for representing a semantically related distribution pattern of features in the feature space. The feature semantic distribution parameters are parameters in an algorithm, and the content feature may be directly mapped by using an algorithm having the feature semantic distribution parameters, to obtain the mapped features.

The mapping refers to a process of mapping a feature from an original feature space (that is, a current feature space) to a new feature space. The feature may be regarded as a representation in a space, and the feature may be usually converted into a vector form, that is, a vector defined in the feature space.

In actual application, model parameters of a semantic-based neural network model (that is, a mapping model) may be used as the feature semantic distribution parameters. For example, the content feature may be mapped by using a combination of one or more of neural network models such as a convolutional neural network (CNN), a recurrent neural network (RNN), and a deep neural network (DNN). The feature semantic distribution parameters are model parameters of the neural network model. Specifically, using the convolutional neural network as an example, parameters (that is, the feature semantic distribution parameters) of convolutional layers are usually a set of filters or convolutional kernels. A new feature mapping (that is, the mapped features) may be obtained after a convolution operation is performed between the content feature and the convolutional kernels. The new feature mapping may be considered as a feature extracted from the content feature under the action of the convolutional kernels, and the new feature mapping follows a distribution pattern corresponding to the convolutional kernels.

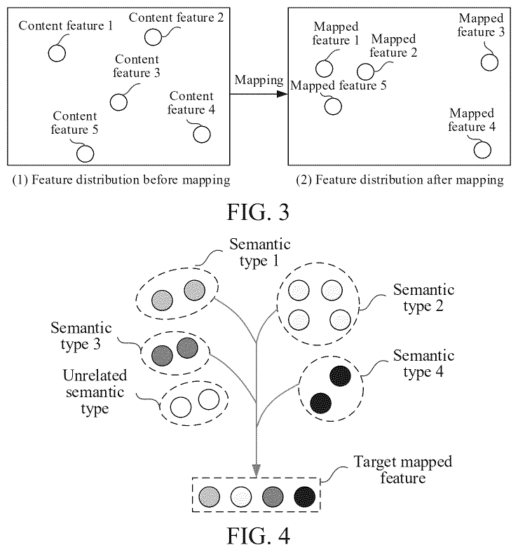

For example, in this embodiment of this application, the server may invoke a preset neural network model, and may extract content features 1 to 5 from media content 1 to 5 in the media resource and map the content features 1 to 5 to obtain mapped features 1 to 5 by using the feature semantic distribution parameters. Since the mapped features 1 to 5 follow the distribution pattern corresponding to the feature semantic distribution parameters, distribution situations of the mapped features 1 to 5 match semantics corresponding to the mapped features 1 to 5. FIG. 3 is a schematic diagram of feature distribution before and after mapping. (1) shows a distribution situation of the content features 1 to 5 in the feature space before mapping, and (2) shows a distribution situation of the mapped features 1 to 5 in the feature space. Due to vary meaning and importance of each feature, apparently, the five feature points of the content features 1 to 5 before mapping are scattered in the feature space, lacking a meaningful structure. In the five feature points of the mapped features 1 to 5 after mapping, semantically related feature points become closer in the feature space, for example, feature points of the semantically related mapped feature 1, mapped feature 2, and mapped feature 5 have a reduced distance in the feature space, and semantically unrelated feature points become farther apart in the feature space, for example, feature points of the semantically unrelated mapped feature 1 and mapped feature 3 have an increased distance in the feature space. Apparently, in this embodiment of this application, the content features are mapped by using the feature semantic distribution parameters, so that a feature distance between semantically similar/identical features can be reduced, and a feature distance between semantically different/irrelevant features can be increased. In this way, the mapped features have a better semantic feature expression capability and are easier to distinguish, thereby enabling better semantic recognition and classification by using the mapped features, and improving the accuracy of semantic recognition and classification.

In some implementations, non-linear transformation and linear transformation may be sequentially performed on the content feature, to better extract and learn the features based on semantics, thereby improving the accuracy of semantic recognition. Specifically, the feature semantic distribution parameters include linear distribution parameters and non-linear distribution parameters, and the performing feature mapping on the content feature by using preset feature semantic distribution parameters, to obtain the mapped features includes: performing non-linear transformation on the content feature by using the preset non-linear distribution parameters, to obtain intermediate features; and performing linear transformation on the intermediate features by using the preset linear distribution parameters, to obtain the mapped features.

For example, the non-linear distribution parameters include a weight matrix W₁, a bias b₁, and an activation function. Linear transformation may be performed on a content feature x by using a weighted summation operation (h₁=W₁*x+b₁), to obtain a transformed feature h₁. Then activation processing is performed on the transformed feature h₁ by using the activation function such as a sigmoid function or a ReLU function, to obtain an intermediate feature h₂. More complex data features can be learned through non-linear transformation, and these features usually cannot be expressed by using simple linear transformation. The linear distribution parameters include a weight matrix W₂ and a bias b₂. Linear transformation may be performed on the intermediate feature h₂ by using a weighted summation operation (y=W₂*h₂+b₂), to obtain a mapped feature y. After non-linear transformation is performed, linear transformation is performed by using the linear distribution parameters, so that complex features obtained after the non-linear transformation can be mapped to obtain a linearly separable result, thereby improving the accuracy of using the mapped features in the semantic recognition process.

In actual application, a mapping process of the content feature may be implemented by using a multilayer perception. The multilayer perception may usually include an input layer, a hidden layer, and an output layer. In some implementations, a two-layer perception may be used to implement the mapping process of the content feature. Specifically, the two-layer perception includes a hidden layer and an output layer, and the non-linear distribution parameters and the linear distribution parameters are respectively parameters of the hidden layer and the output layer. In this way, in actual application, the server may invoke the two-layer perception, perform non-linear transformation on the content feature by using the hidden layer, to obtain the intermediate features, and then perform linear transformation on the intermediate features by using the output layer, to obtain the mapped features.

In some implementations, the feature semantic distribution parameters may be model parameters of the pre-trained neural network model.

In some implementations, a distribution pattern of samples according to categories may be mined through contrastive learning with positive and negative samples, so that the obtained feature semantic distribution parameters learn a semantically related distribution pattern.

Specifically, before the mapping the content feature by using preset feature semantic distribution parameters, to obtain the mapped features, the method further includes: obtaining a training sample set and initial distribution parameters, the training sample set including positive samples and negative samples; and updating the initial distribution parameters through contrastive learning with the positive samples and the negative samples, to obtain the feature semantic distribution parameters.

The positive samples and the negative samples are samples defined according to a task requirement. In this embodiment of this application, the positive samples and the negative samples are related to the content feature. For example, training content features that belong to a target category may be used as the positive samples, and training content features that do not belong to the target category may be used as the negative samples.

The contrastive learning is a self-supervised learning method, which aims at learning an effective feature representation by comparing similarities or differences between different samples, to make samples of the same category closer and samples of different categories farther apart. Therefore, in this embodiment of this application, the contrastive learning method is used to enable the feature semantic distribution parameters to learn the distribution pattern of samples according to categories, where the categories may be determined according to semantic types.

Specifically, using an example in which the two-layer perception is used to implement the mapping process of the content feature, the two-layer perception may be trained by using the training sample set. The two-layer perception maps each inputted sample to a feature space, to obtain eigenvectors. Then, the eigenvectors corresponding to positive and negative samples are calculated by using a loss function such as a contrastive loss function to obtain a loss function of the contrastive learning, a gradient of the loss function is calculated by using a back propagation algorithm, and parameters (the initial distribution parameters) of the two-layer perception are updated by using an optimizer. The foregoing operations are iteratively repeated until the model converges or a preset number of iterations is reached, to obtain a trained two-layer perception. Parameters of the trained two-layer perception are the feature semantic distribution parameters.

In some implementations, a plurality of groups of samples may be constructed based on the training content features, the training query features, and the content categories, to perform contrastive learning with rich training data, so that the feature semantic distribution parameters have a better expression effect, thereby improving the accuracy of the obtained mapped features.

Specifically, the positive samples include a first sample and a second sample, where the first sample includes relevant training content features and training query features, and the second sample includes relevant training content features and content categories, and the negative samples include a third sample and a fourth sample, where the third sample includes irrelevant training content features and training query features, and the fourth sample includes irrelevant training content features and content categories.

The updating the initial distribution parameters through contrastive learning with the positive samples and the negative samples, to obtain the feature semantic distribution parameters includes: calculating a first similarity value between the relevant training content features and training query features, a second similarity value between the relevant training content features and content categories, a third similarity value between the irrelevant training content features and training query features, and a fourth similarity value between the irrelevant training content features and content categories; calculating a contrastive loss value according to the first similarity value, the second similarity value, the third similarity value, and the fourth similarity value; and updating the initial distribution parameters according to the contrastive loss value, to obtain the feature semantic distribution parameters.

The training content features and the training query features are a content feature and query features for contrastive learning. For example, the relevant training content features and training query features may be extracted from the media content and its corresponding query text by using the contrastive language-image pre-training model, and then irrelevant features in the extracted features may be randomly combined to obtain the irrelevant training content features and training query features.

The content categories are categories determined by classifying the training content features. For example, the content categories may be category prototypes, a pre-trained classification model is used to determine categories of the training content features, and for each category, a prototype vector is initialized to represent a feature distribution of the category, and the prototype vector is used as a relevant content category. The content category may be semantically related such as a prototype vector of a semantic type, or may be semantically unrelated. Then, training content features and content categories that are not related are randomly combined to obtain irrelevant training content features and content categories.

For example, the contrastive loss value may be calculated by using the following formula:

$${ℒ}_{scl} = - log \frac{{\overbrace{{\sum }_{i} exp ( {h}_{q} \cdot {\hat{h}}_{υ}^{r , i} / τ )}}^{( 1 )} + {\overbrace{{\sum }_{i} exp ( ℬ ( G ( {\hat{h}}_{υ}^{r , i} ) ) \cdot {\hat{h}}_{υ}^{r , i} / τ )}}^{( 2 )}}{{\underbrace{{\sum }_{i} exp ( {h}_{q} \cdot {h}_{υ}^{ir , l} / τ )}}_{( 3 )} + {\underbrace{{\sum }_{i , j} exp ( ℬ ( j ) \cdot {h}_{υ}^{ir , l} / τ )}}_{( 4 )} + ( 1 ) + ( 2 )} ;$$

h_{q} is a training query feature,

$${\hat{h}}_{υ}^{r , i}$$

is a training content feature relevant to

$${h}_{q} , ℬ ( G ( {\hat{h}}_{υ}^{r , i} ) )$$

is a content category related to

$${\hat{h}}_{υ}^{r , i} , {\hat{h}}_{υ}^{ir , l}$$

is a training content features unrelated to h_{q}, [symbol] (j) is a content category unrelated to

$${\hat{h}}_{υ}^{r , i} , {\sum }_{i} exp ( {h}_{q} \cdot {\hat{h}}_{υ}^{r , i} / τ )$$

is a first similarity value (that is, (1) in the foregoing formula),

$${\sum }_{i} exp ( ℬ ( G ( {\hat{h}}_{υ}^{r , i} ) ) \cdot {\hat{h}}_{υ}^{r , i} / τ )$$

is a second similarity value (that is, (2) in the foregoing formula),

$${\sum }_{i} exp ( {h}_{q} \cdot {\hat{h}}_{υ}^{ir , l} / τ )$$

is a third similarity value (that is, (3) in the foregoing formula),

$${\sum }_{i , j} exp ( ℬ ( j ) \cdot {\hat{h}}_{υ}^{ir , l} / τ )$$

is a fourth similarity value (that is, (4) in the foregoing formula), τ is a hyper-parameter, and a value of τ may be set according to experimental experience and a specific problem. For example, a value range of τ is usually [0, +∞]. Specifically, the similarity values in the foregoing formula are used to represent a similarity between two features in a sample. For example, using the first similarity value as an example, a sum of products of relevant training content features and training query features in the first sample is calculated and divided by the hyper-parameter τ, and finally the result is transformed into a probability distribution by using an exponential function. The probability distribution is used to represent the similarity between the relevant training content features and training query features in the first sample.

In this embodiment of this application, the first sample to the fourth sample are used for contrastive learning. Therefore, the first sample and the third sample are content features relevant and irrelevant to the query features, which may help learn a similarity and a difference between semantic information of the samples. The second sample and the fourth sample are content features relevant and irrelevant to the content categories, which may help learn different content categories of the samples, to improve a classification capability and a generalization capability of the feature semantic distribution parameters (that is, a corresponding neural network model), thereby obtaining a better feature expression effect.

In some implementations, during each process of iteratively updating the distribution parameters according to the contrastive loss value, the content categories relevant to the training content features may be updated at the same time, so that the updated content categories are used as content categories for samples in a next round, to obtain a more accurate training result. For example, the content categories relevant to the training content features may be updated by using the following formula:

$$ℬ ( G ( {\hat{h}}_{υ}^{r , i} ) ) = αℬ ( G ( {\hat{h}}_{υ}^{r , i} ) ) + ( 1 - α ) {\hat{h}}_{υ}^{r , i} ;$$

$$ℬ ( G ( {\hat{h}}_{υ}^{r , i} ) )$$

is a content category relevant to a training content feature

$${\hat{h}}_{υ}^{r , i} ,$$

α is a momentum coefficient used in each iterative update, and a value of αmay be set according to experimental experience and a specific problem. For example, a value range of α is usually [0, 1], and a value of α may be 0.9.

In some implementations, augmentation processing is performed on the training sample set, to increase the diversity of the sample set, and improve the performance and generalization capabilities of the model, thereby improving the accuracy of the obtained mapped features. Specifically, the training sample set is obtained through the following operations: obtaining an initial training sample set; and performing augmentation processing on the initial training sample set, to obtain the training sample set, the augmentation processing including at least one of deleting sample features, copying sample features, or adding perturbed sample features, and the sample features including at least one of the training content features or the training query features.

The initial training sample set is an original data set collected before contrastive learning. For example, the initial training sample set may be an existing public data set or a data set manually created based on a task or an application scenario.

For example, one or more training content features may be deleted from the sample, to perform the process of deleting sample features. One or more training content features may be copied from the sample and added to the training sample set, to perform the process of copying sample features. Perturbed content feature and/or perturbed query features may be added to the training sample set, to perform the process of adding perturbed sample features.

In some implementations, the sample features may be deleted or copied based on a specified probability. The specified probability is a deletion probability set according to a task or an application scenario. Specifically, training content features and/or training query features with a specified probability P₁ may be deleted, and training content features and/or training query features with a specified probability P₂ may be copied and added to the training sample set. The specified probabilities P₁ and P₂ may be the same or may be different.

In some implementations, a perturbed sample feature may be generated based on any sample feature in the initial training sample set, and then the sample feature is replaced with the corresponding perturbed sample feature, to perform the process of adding perturbed sample features. Specifically, the training query features and the training content features in the sample features may be linearly mixed to generate new perturbed sample features. Generating the new perturbed sample features through linear mixing can help increase the diversity and generalization performance of the data set, and also help the model suppress overfitting.

For example, a perturbed query feature may be generated from any training query feature by using the following formula:

$${h}_{q} = max ( λ , 1. - λ ) {h}_{q} + min ( λ , 1. - λ ) {\hat{h}}_{υ}^{r , i} ;$$

h_{q} on the right side of the equal sign of the formula is a training query feature,

$${\hat{h}}_{υ}^{r , i}$$

is a training content feature relevant to h_{q}, λ represents a linear mixing ratio of a sample, and λ may be randomly generated by binomial distribution Beta (1.0, 1.0). h_{q} on the left side of the equal sign of the formula is a perturbed query feature. Therefore, the perturbed query feature is obtained by performing linear mixing on the training query feature and the relevant training content feature.

For another example, a perturbed content feature may be generated from any training content feature by using the following formula:

$${\hat{h}}_{υ}^{r , i} = max ( λ , 1. - λ ) {\hat{h}}_{υ}^{r , i} + min ( λ , 1. - λ ) {\hat{h}}_{q} ; {\hat{h}}_{υ}^{r , i}$$

on the right side of the equal sign of the formula is a training content feature, h_{q} is a training query feature relevant to ĥ₀^{r,i}, λ represents a linear mixing ratio of a sample, and λ may be randomly generated by binomial distribution Beta (1.0, 1.0).

$${\hat{h}}_{υ}^{r , i}$$

on the left side of the equal sign of the formula is a perturbed content feature. Therefore, the perturbed content feature is obtained by performing linear mixing on the training content feature and the relevant training query feature.

Operation 140: Perform semantic recognition on the mapped features based on the text feature, to determine semantic types corresponding to the mapped features.

Semantic recognition means that in the field of natural language processing, the meaning and context of a text are analyzed to determine the meaning and intent expressed by the text. For example, semantic recognition may be performed on the mapped features by using a combination of one or more of neural network models used for semantic recognition, such as a recurrent neural network (RNN), a gated recurrent unit (GRU), a long short term memory (LSTM) network, and an attention mechanism (Attention) network, to classify the mapped features and obtain categories (that is, the semantic types) of the mapped features.

For example, the server may concatenate the text feature 1 with each of the mapped features 1 to 5 obtained through mapping, to obtain a combined feature 1: (text feature 1, mapped feature 1), a combined feature 2: (text feature 1, mapped feature 2), a combined feature 3: (text feature 1, mapped feature 3), a combined feature 4: (text feature 1, mapped feature 4), and a combined feature 5: (text feature 1, mapped feature 5). Semantic recognition is then performed on each combined feature, to obtain a semantic type of each combined feature through classification. That is, the semantic type of each combined feature is the semantic type of the mapped feature in the combined feature. For example, the semantic recognition result may be: the semantic type 1 includes the mapped feature 2 and the mapped feature 4, the semantic type 2 includes the mapped feature 1, and the semantic type 3 includes the mapped feature 3 and the mapped feature 5.

In some implementations, the text feature and all the mapped features may be concatenated into one feature sequence, to fuse all the features, so that during subsequent feature extraction based on global attention, meanings and semantic relationships of the feature sequence can be better understood, thereby improving the accuracy of the determined semantic types.

Specifically, the performing semantic recognition on the mapped features based on the text feature, to determine semantic types corresponding to the mapped features includes: grouping the text feature and a set formed by the mapped features obtained through mapping, to obtain a feature sequence; performing global attention processing on any mapped feature based on the feature sequence, to obtain a target feature corresponding to the mapped feature; and classifying the target feature corresponding to the mapped feature, to obtain a semantic type corresponding to the mapped feature.

For example, an attention network model may be used to perform global attention processing. The attention network model may be a global self-attention network (GSANet), a multi-head attention network (Transformer), or the like. For example, a feature sequence {text feature 1, mapped feature 1, mapped feature 2, mapped feature 3, mapped feature 4, mapped feature 5} obtained by concatenating the text feature 1 and the mapped features 1 to 5 obtained by mapping may be inputted into the attention network model to perform global attention processing. Under the global attention-based mechanism, the attention network model may adaptively focus on the most relevant features in the input sequence, and process these features, to obtain more useful feature representations, for example, output a feature sequence {target feature 1, target feature 2, target feature 3, target feature 4, target feature 5, target feature 6}, where the target features 2 to 6 are respectively target features corresponding to the mapped features 1 to 5. Then, after a probability distribution of each semantic type for the target features 1 to 6 is calculated by using a classification network such as a fully connected network, a semantic type with a maximum probability corresponding to each target feature is used as its corresponding semantic type, so that classification processing is performed by using the classification network, to obtain the semantic type of each target feature, thereby determining the semantic types of the mapped features.

In some implementations, to improve the accuracy of the determined semantic types, global attention processing may be performed by using the pre-trained attention network model. Specifically, the attention network model may be trained by using a cross-entropy loss function, and the trained attention network model is used to perform global attention processing.

In some implementations, a semantic-based neural network model (for example, the mapping model) and a neural network model for semantic recognition (for example, the attention network model) may be trained by using the training sample set. For example, in a process of training the mapping model by using the training sample set, a result outputted by the mapping model may be used to train the attention network model, a loss of the attention network model is calculated by using the cross-entropy loss function, and the trained attention network model is used to perform global attention processing, so that the mapping model and the attention network model may be trained at the same time through one training process.

In some implementations, in a process of training the semantic-based neural network model and the neural network model for semantic recognition at the same time, a content category of a sample may be used as a training objective for the neural network model for semantic recognition, that is, a semantic type, or the semantic type may be customized according to a task or a requirement.

Operation 150: Group the mapped features corresponding to the same semantic type into the same combination, and determine target mapped features meeting a relevance condition from different combinations.

The relevance is configured for representing a relevance degree between the combined features. For example, the relevance may be in a form of a feature similarity such as a cosine similarity or a Euclidean distance, a relevance coefficient such as a Pearson relevance coefficient, or an overall relevance degree such as a covariance.

The relevance condition is a condition for determining whether the plurality of mapped features are relevant. The relevance condition may be determined according to a task requirement or an application scenario, and may have a plurality of forms. For example, the relevance condition may be a relevance threshold or a relevance ranking. For example, when a relevance value of any two mapped features in all semantic types is greater than the relevance threshold, the two mapped features are target mapped features. For another example, all mapped features in each semantic type are ranked according to the relevance coefficient, and the top k mapped features in each semantic type are used as target mapped features, where k is a positive integer set according to the task requirement or the application scenario.

For example, after the mapped features 1 to 5 are classified into the semantic types 1 to 3, the server may calculate the feature similarity pairwise between mapped features in different semantic types. For example, the server may determine the following pairwise combinations in the semantic types 1 to 3: mapped feature 2-mapped feature 1, mapped feature 2-mapped feature 3, mapped feature 2-mapped feature 5, mapped feature 4-mapped feature 1, mapped feature 4-mapped feature 3, mapped feature 4-mapped feature 5, mapped feature 1-mapped feature 3, and mapped feature 1-mapped feature 5. The two mapped features in these combinations come from different semantic types. In this way, the cosine similarity for each combination may be calculated, and the mapped features in combinations with a cosine similarity greater than the relevance threshold is used as the target mapped features. For example, if the cosine similarity between the mapped feature 2 and the mapped feature 1 and the cosine similarity between the mapped feature 1 and the mapped feature 5 are greater than the relevance threshold, the mapped feature 1, the mapped feature 2, and the mapped feature 5 are used as the target mapped features.

In some implementations, several target mapped features most similar to the text feature may be determined from each semantic type, to return one or more search results of a plurality of different semantic types, to provide the user with diverse search results and more suitable search results.

Specifically, the determining target mapped features meeting a relevance condition from different combinations includes: determining, in each combination, a ranking number of similarity between each mapped feature and the text feature; and selecting, from each combination, the mapped features with ranking numbers not exceeding a preset number as the target mapped features.

The preset number refers to a value determined according to a task requirement or an application scenario.

For example, after n mapped features corresponding to n pieces of media content are classified into semantic types, the server may calculate feature similarities between mapped features in different semantic types and the text feature. In addition, mapped features in each semantic type are ranked according to the feature similarities in descending order, and the Top-K mapped features in each semantic type are used as the target mapped features. For example, two mapped features with a maximum feature similarity in each semantic type are used as the target mapped features. If there are m semantic types, 2m target mapped features may be determined.

In some implementations, to simplify the search results, and provide the user with appropriate search results, the preset number may be set to 1, meaning that the mapped feature with a maximum similarity with the text feature in each semantic type is used as the target mapped feature.

In some implementations, the target mapped features may be determined based on the similarity between the target features corresponding to the mapped features and the text feature. For example, the attention network model may include a global attention network and a fully connected network. After the target features corresponding to each mapped feature are extracted by using the global attention network, the target features are classified by using a classification network such as the fully connected network, to obtain semantic types of the mapped features corresponding to each target feature. Then, the feature similarity between the target features corresponding to the mapped features and the text feature is calculated, and the Top-K mapped features with the maximum feature similarity in each semantic type are used as the target mapped features.

In some implementations, the target mapped features may be determined only from each semantic type related to the search information, to filter the semantic types corresponding to the search information, reduce the number of target mapped features, and improve the precision and accuracy of the search results. For example, as shown in a schematic diagram of determining target mapped features in FIG. 4, when the search information is “Pork cooking”, mapped features corresponding to a plurality of pieces of media content are classified into semantic types 1 to semantic types 4 corresponding to “Region 1, Region 2, Region 3, and Region 4”, and mapped features corresponding to some media content are misclassified into semantic types unrelated to “pork cooking”, for example, “rice noodles in a region”. In this case, the target mapped features may be determined only from the semantic types 1 to the semantic types 4 related to “pork cooking”, that is, “Region 1, Region 2, Region 3, and Region 4”, rather from the semantic types unrelated to “pork cooking”. In actual application, a plurality of methods may be used to determine whether the search information is related to the semantic types. For example, the similarity between the search information and the semantic types may be calculated based on a knowledge graph, and semantic types with a similarity to the search information greater than a preset threshold are used as related semantic types. Alternatively, semantic classification may be performed based on a machine-learning classification method, a semantic classification model is trained, and a semantic category to which the search information belongs is predicted as the semantic type related to the search information.

Operation 160: Determine search results for the search information from the media resource according to the target mapped features.

For example, the server may use the media content corresponding to the target mapped features as the search results and return the search results to the application. For example, the media content 1, the media content 2, and the media content 5 that respectively correspond to the mapped feature 1, the mapped feature 2, and the mapped feature 5 are returned to the application as the search results.

In some implementations, the search results may be returned in a form of a search list. Specifically, the determining search results for the search information from the media resource according to the target mapped features includes: determining target media content corresponding to the target mapped features in the media resource; and adding the target media content to a search list, to obtain the search results for the search information.

The target media content is media content corresponding to the target mapped features.

For example, in actual application, the search results in the form of the search list may be generated, and the list may quickly display all search results, to improve the search efficiency. In addition, the search results in the form of the list offer a certain level of scalability, allowing new search results to be easily added without the need to reconstruct the entire result. Specifically, the server may read the media content corresponding to the target mapped features, and add the media content to the search list. For example, using an example in which the media content is an image, the search list may be [image 101, image 201, image 704, image 801, image 1101, image 1202], and the search list includes six images corresponding to a plurality of target mapped features.

In some implementations, the target media content may be added to the search list first, and then the target media content in the search list is ranked. The operation of adding first and then ranking allows the search list to include all search results. In addition, the ranking ensures that the most relevant or highest-quality search results are ranked at the top, making it easier for the user to read and search, thereby improving the user experience. Specifically, the adding the target media content to a search list, to obtain the search results for the search information includes: adding the target media content to the search list, to obtain an updated search list; and
ranking the target media content in the updated search list according to search parameters, to obtain the search results for the search information, the search parameters including at least one of similarity between the target media content and the search information, visual quality, timestamp, and popularity.

The similarity with the search information refers to a degree of similarity between the media content and the search information. In some implementations, the similarity between the media content and the search information may be a similarity between the mapped features corresponding to the media content and the content features, so that the similarity may be directly obtained for ranking, and content more similar to the search information is ranked at the top of the search list.

The visual quality refers to a level of a visual effect of the media content. For example, the visual quality may include a combination of one or more of parameters such as clarity, resolution, image stability, and contrast, to rank content with better visual quality at the top of the search list.

The timestamp is time information corresponding to the media content. For example, the timestamp may be a publication time of the media content, and content with newer timestamps is ranked at the top of the search list.

The popularity refers to a level of attention the media content receives. For example, the popularity may include a combination of one or more of a click-through rate, a share rate, a comment rate, a like rate, and the like, so that content with higher popularity is ranked at the top of the search list.

For example, the server may add the target media content to the search list, to obtain an initial search list such as [image 101, image 201, image 704, image 801, image 1101, and image 1202], then score or weight the media content in the initial search list according to at least one search parameter such as the similarity with the search information, the visual quality, the timestamp, and the popularity, rank the media content according to scoring or weighting results, for example, rank the media content with higher scores at the top, to obtain a ranked search list such as [image 801, image 201, image 1202, image 101, image 704, and image 1101], and use the ranked search list as the search results and return the search list to the application client.

In some implementations, different search parameters may be selected according to different application scenarios or requirements. For example, when the media content is an image, the search parameters include the visual quality, to provide high-quality image content to the user; and when the media content is music, the search parameters include the popularity, to provide music content with higher popularity to the user.

In some implementations, if the user enters a plurality of pieces of search information, corresponding target media content may be determined for each piece of search information, and the target media content corresponding to the plurality of pieces of search information is added to the same search list, to implement a joint search on the plurality of pieces of search information, thereby improving the search efficiency and user experience. Specifically, in actual application, if the user enters a plurality of pieces of search information, the search information may be aggregated according to relevance between the search information, to finally obtain several pieces of irrelevant target search information. For example, search information with relevance higher than a preset value is concatenated into one piece of target search information, to determine corresponding target media content for the several pieces of irrelevant target search information, and then add the target media content corresponding to the plurality of pieces of search information to the same search list.

The content search solution provided in this embodiment of this application may be applied to various content search scenarios. For example, using a search application as an example, search information and a media resource are obtained, the media resource including a plurality of pieces of media content; a text feature is extracted from the search information, and a content feature is extracted from the media content; the content feature is mapped by using feature semantic distribution parameters, to obtain mapped features, distribution of the mapped features following a distribution pattern corresponding to the feature semantic distribution parameters; semantic recognition is performed on the mapped features based on the text feature, to determine semantic types corresponding to the mapped features; target mapped features meeting a relevance condition are determined from different semantic types; and search results for the search information are determined from the media resource according to the target mapped features.

Therefore, in this embodiment of this application, the content features extracted from the media content are mapped by using the feature semantic distribution parameters, so that a feature distance between semantically similar/identical features can be reduced, and a feature distance between semantically different/irrelevant features can be increased. In this way, the mapped features have a better semantic feature expression capability and are easier to distinguish, thereby enabling better semantic recognition and classification by using the mapped features, and improving the accuracy of semantic recognition and classification, to provide accurate search results. Then, the semantic types corresponding to the mapped features are determined according to the text feature extracted from the search information, to select the target mapped features meeting the relevance condition from different semantic types, to return a plurality of diverse search results of different semantic types, to meet diverse search intents of users. Therefore, in this embodiment of this application, with reference to the mapping process based on the feature semantic distribution parameters and the feature filtering process based on different semantic types, accurate and diverse search results can be provided based on search intents of users, thereby meeting user needs and increasing user retention.

According to the method described in the foregoing embodiments, the following further describes the method in detail.

In this embodiment, the method of this embodiment of this application is described in detail by using a scenario for video search as an example.

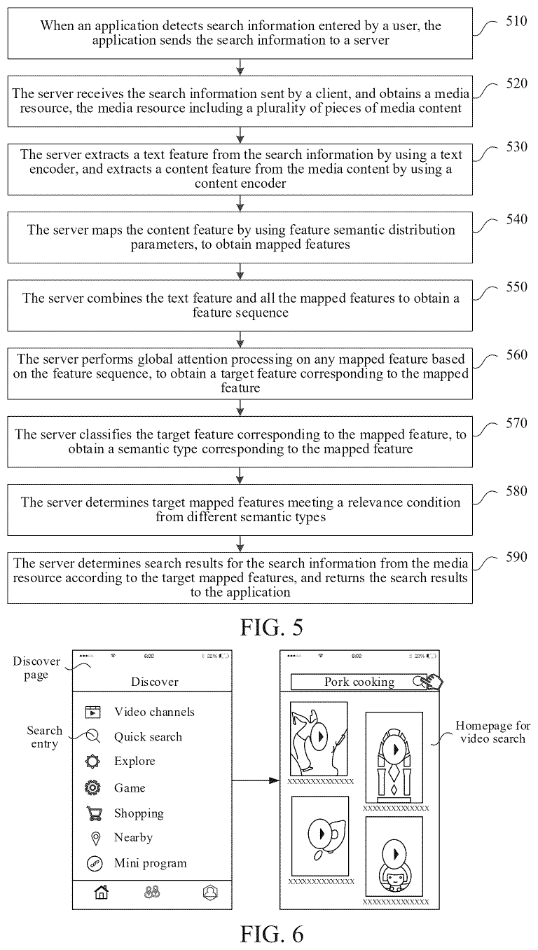

As shown in FIG. 5, a specific process of the content search method is as follows:

Operation 510: When an application detects search information entered by a user, the application sends the search information to a server.

For example, this embodiment of this application may be applied to a mini program for video search. An entry of the mini program may be set in a social application. In this application scenario, the search information entered by the user is a text, and the media content is a video. As a schematic diagram of a video search interface shown in FIG. 6, a Discover page of a social application client may display a search entry “Search” of the mini program. The user may tap the entry to jump to home page for video search, and enter a search text “pork cooking” in a search bar displayed on the home page. The client may send the search text “pork cooking” to the server of the application.

Operation 520: The server receives the search information sent by a client, and obtains a media resource, the media resource including a plurality of pieces of media content.

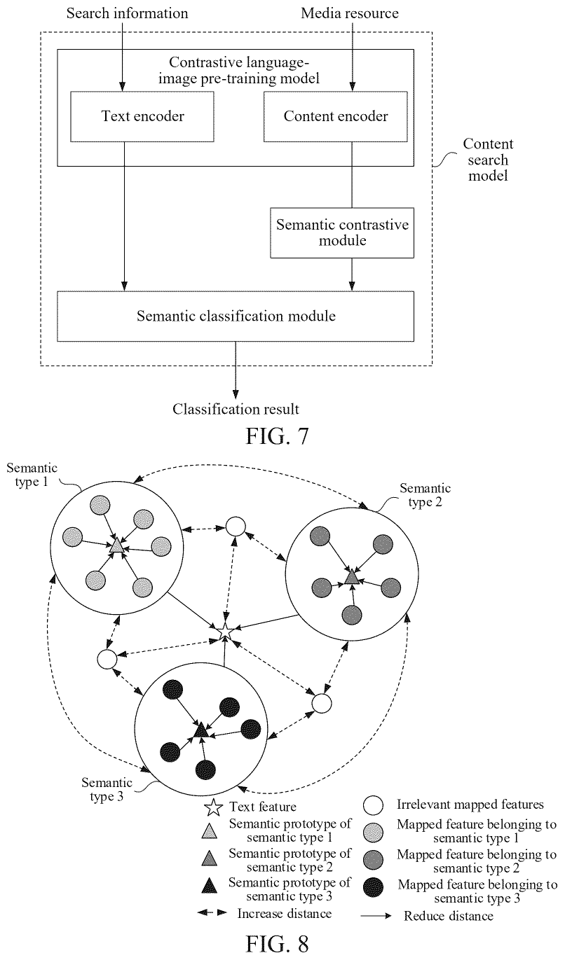

For example, after receiving the search information “cooking pork” sent by a terminal, the server may invoke video data (that is, the media resource) stored in a database. In addition, the server may be provided with a content search model to implement the content search method of this application. As a schematic structural diagram of a content search model shown in FIG. 7, the content search model may include a contrastive language-image pre-training model (that is, the pre-trained neural network model), a semantic contrastive module (a semantic-based neural network model), and a semantic classification module (a neural network model for semantic recognition). The pre-trained neural network model is configured to extract a text feature and a content feature from a search text and a video respectively, the semantic-based neural network model is configured to map data, and the neural network model for semantic recognition is configured to classify different semantics of the data. The server may input the search information and the media resource including a plurality of videos to the content search model, and finally output a classification result of the plurality of videos based on the search text.

Operation 530: The server extracts a text feature from the search information by using a text encoder, and extracts a content feature from the media content by using a content encoder.

For example, the server may input the search information “pork cooking” and invoked video data into a visual branch of a CLIP model (that is, the pre-trained neural network model), that is, the content encoder (for example, ViT) and a natural language branch, that is, the text encoder (for example, BERT), to extract a corresponding query feature (that is, the text feature) and a data feature (that is, the content feature).

Operation 540: The server maps the content feature by using feature semantic distribution parameters, to obtain mapped features.

For example, the server may perform re-mapping on the data feature by using the semantic contrastive learning module (that is, the semantic-based neural network model), to obtain a stable re-encoded data feature (that is, the mapped feature).

Specifically, the semantic contrastive learning module performs robust feature mapping through contrastive learning with positive and negative samples, where the positive samples include: data with the same semantics and relevant data and queries. The negative samples include: data with different semantics and irrelevant data and queries. As a schematic diagram of a mapping effect of a semantic contrastive learning module shown in FIG. 8, logic of the semantic contrastive learning module is shown. It can be learned from the figure that after being processed by the contrastive learning module, feature distances between mapped features in semantic types 1 to 3 related to the text feature can be reduced, and feature distances between the mapped features in the related semantic types and semantic prototypes can also be reduced. In addition, distances between the different semantic types 1 to 3 can be increased, or distances between an irrelevant mapped features that do not belong to any semantic type and a semantic type relevant to the text feature and the text feature can be increased. Therefore, the semantic contrastive learning module in this embodiment of this application can reduce a distance between all data with the same semantics and queries (that is, text features), and reduce a distance from irrelevant data and data with different semantics, so that the mapped features have a better semantic feature expression capability and are easier to distinguish and classify. In a specific implementation, the semantic contrastive learning module is implemented by a multilayer perception with two layers. In addition, supervised training is performed on calculation of the contrastive learning loss according to the foregoing described positive and negative samples.

In addition, in this embodiment of this application, a data set (that is, a training sample set) with a fine-grained semantic label is used for training. Specifically, for each piece of image data in the data set, in addition to general text descriptions, the data set further needs to provide fine-grained semantic descriptions such as “Dog” and “Husky”. Models to be trained (the semantic contrastive learning module and the Transformer model) are completed on four RTX 3090 GPUs, and the models are trained by using a PyTorch training framework and an ADAMW optimizer. In addition, to further mine training data, in this embodiment of this application, data augmentation operations may be performed on query and data features, including the following four types: 1. Deletion (that is, deleting sample features): Randomly deleting one data feature; 2. Copy (that is, copying sample features): Randomly copying one data feature; 3. Query feature disturbance (that is, adding perturbed query features): Randomly perturbing the query feature by using one relevant data feature; and 4. Data feature disturbance (that is, adding perturbed content features): Randomly perturbing one data feature by using a query feature.

Operation 550: The server combines the text feature and all the mapped features to obtain a feature sequence.

For example, the server may serialize and concatenate the query features and the re-encoded data features, to obtain the feature sequence.

Operation 560: The server performs global attention processing on any mapped feature based on the feature sequence, to obtain a target feature corresponding to the mapped feature.

For example, the server may input the feature sequence into the semantic classification module such as a Transformer model (multi-head attention network). The Transformer model performs global attention processing according to an overall feature representation of input features, and outputs a processed feature sequence. The feature sequence includes the target feature corresponding to each mapped feature.

Operation 570: The server classifies the target feature corresponding to the mapped feature, to obtain a semantic type corresponding to the mapped feature.

For example, the last layer of the Transformer model is a fully connected network. The server determines the semantic types corresponding to each target feature by using the fully connected network, to classify each data feature into a corresponding semantic category, that is, obtain a classification result of the plurality of videos based on the search text. As a schematic diagram of a mapping effect of a semantic contrastive learning module shown in FIG. 8, the circles (O) in different grayscales represent different predicted semantic results (that is, different semantic types) provided by the Transformer model. For example, the semantic types may separately provide the user with cooking methods from different regions (for example, Region 1, Region 2, Region 3, and Region 4).

Operation 580: The server determines target mapped features meeting a relevance condition from different semantic types.

For example, the server may select, from different semantic results, several pieces of data highly related to the search information to form a final search result. For example, one data set (that is, target mapped feature) may be selected from each of the four different semantic types to form the final result.

Operation 590: The server determines search results for the search information from the media resource according to the target mapped features, and returns the search results to the application.

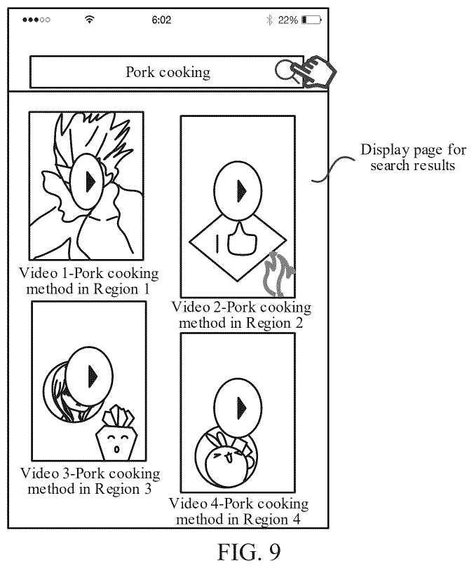

For example, the server may form a search list [video 1, video 2, video 3, and video 4] corresponding to the four selected target mapped features, and return the search list to the application. The application may display images of the video 1 to the video 4 on a display page for search results shown in FIG. 9. The four videos displayed on the page respectively correspond to pork cooking methods in Region 1, Region 2, Region 3, and Region 4. The user may tap any one of the videos to view.

In this embodiment of this application, semantic contrastive learning technologies are used to map data to a fixed and stable point (that is, a stable re-encoded data feature is obtained), creating a clear distinction from samples with different semantics. The Transformer model is used to perform semantic classification on the data, and finally highly relevant points are selected from different semantics to form the final search results, to resolve the problem that it is difficult to mine diversity by using the Top-K method.

To better implement the foregoing method, an embodiment of this application further provides a content search apparatus. The content search apparatus may be specifically integrated into an electronic device. The electronic device may be a device such as a terminal or a server. The terminal may be a device such as a mobile phone, a tablet computer, a smart Bluetooth device, a notebook computer, or a personal computer. The server may be a single server or may be a server cluster including a plurality of servers.

For example, in this embodiment, the method in the embodiments of this application is described in detail by using an example in which the content search apparatus is specifically integrated into a server.

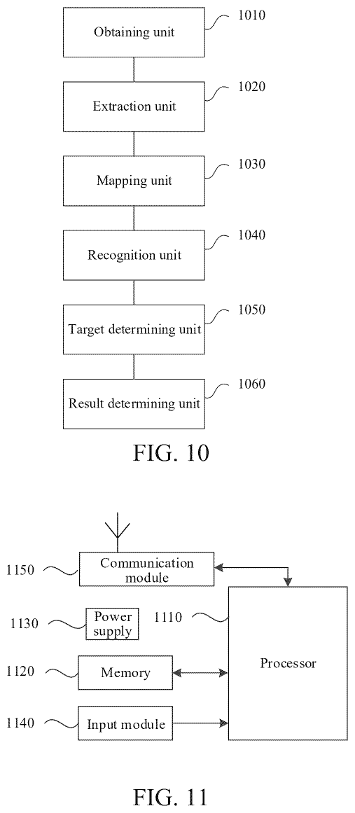

For example, as shown in FIG. 10, the content search apparatus may include an obtaining unit 1010, an extraction unit 1020, a mapping unit 1030, a recognition unit 1040, a target determining unit 1050, and a result determining unit 1060.

The obtaining unit 1010 is configured to obtain search information and a media resource, the media resource including a plurality of pieces of media content.

The extraction unit 1020 is configured to extract a text feature from the search information, and extract a content feature from the media content.

The mapping unit 1030 is configured to map the content feature to mapped features, a distance between different mapped features being related to semantic relevance between the different mapped features.

The recognition unit 1040 is configured to perform semantic recognition on the mapped features based on the text feature, to determine semantic types corresponding to the mapped features.

The target determining unit 1050 is configured to group the mapped features corresponding to the same semantic type into the same combination, and determine target mapped features meeting a relevance condition from different combinations.

The result determining unit 1060 is configured to determine search results for the search information from the media resource according to the target mapped features.

In some embodiments, the extraction unit 1020 may be specifically configured to: obtain a pre-trained neural network model, the pre-trained neural network model including a text encoder and a content encoder, and the pre-trained neural network model being obtained by training search information samples and media content samples; extract the text feature from the search information by using the text encoder; and extract the content feature from the media content by using the content encoder.

In some embodiments, the mapping unit 1030 is specifically configured to perform feature mapping on the content feature by using preset feature semantic distribution parameters, to obtain the mapped features.

In some embodiments, the feature semantic distribution parameters include non-linear distribution parameters and linear distribution parameters, and the mapping unit 1030 is specifically configured to perform non-linear transformation on the content feature by using the preset non-linear distribution parameters, to obtain intermediate features; and perform linear transformation on the intermediate features by using the preset linear distribution parameters, to obtain the mapped features.

In some embodiments, the content search apparatus further includes a training unit, and the training unit is specifically configured to: obtain a training sample set and initial distribution parameters, the training sample set including positive samples and negative samples; and update the initial distribution parameters through contrastive learning with the positive samples and the negative samples, to obtain the feature semantic distribution parameters.

In some implementations, the positive samples include a first sample and a second sample, the first sample including relevant training content features and training query features, and the second sample including relevant training content features and content categories; and the negative samples include a third sample and a fourth sample, the third sample including irrelevant training content features and training query features, and the fourth sample including irrelevant training content features and content categories. The training unit is specifically configured to calculate a first similarity value between the relevant training content features and training query features, a second similarity value between the relevant training content features and content categories, a third similarity value between the irrelevant training content features and training query features, and a fourth similarity value between the irrelevant training content features and content categories; calculate a contrastive loss value according to the first similarity value, the second similarity value, the third similarity value, and the fourth similarity value; and update the initial distribution parameters according to the contrastive loss value, to obtain the feature semantic distribution parameters.

In some implementations, the training unit is further configured to obtain an initial training sample set; perform augmentation processing on the initial training sample set, to obtain the training sample set, the augmentation processing including at least one of deleting sample features, copying sample features, or adding perturbed sample features, and the sample features including at least one of the training content features or the training query features.

In some embodiments, the recognition unit 1040 is configured to combine the text feature and a set formed by the mapped features obtained through mapping, to obtain a feature sequence; perform global attention processing on any mapped feature based on the feature sequence, to obtain a target feature corresponding to the mapped feature; and classify the target feature corresponding to the mapped feature, to obtain a semantic type corresponding to any mapped feature.

In some embodiments, the target determining unit 1050 is configured to determine, in each combination, a ranking number of similarity between each mapped feature and the text feature; and select, from each combination, the mapped features with ranking numbers not exceeding a preset number as the target mapped features.

In some embodiments, the result determining unit 1060 is configured to determine target media content corresponding to the target mapped features from the media resource; and add the target media content to a search list, to obtain the search results for the search information.

In some embodiments, the result determining unit 1060 is configured to add the target media content to a search list, to obtain an updated search list. rank the target media content in the updated search list according to search parameters, to obtain the search results for the search information, the search parameters including at least one of similarity between the target media content and the search information, visual quality, timestamp, and popularity.

During specific implementation, the above units may be implemented as independent entities, or may be combined in different ways, or may be implemented as the same entity or a plurality of entities. For specific implementation of the above units, reference may be made to the above method embodiments. This is not described herein.

Therefore, the content search apparatus in this embodiment includes an obtaining unit, an extraction unit, a mapping unit, a recognition unit, a target determining unit, and a result determining unit. The obtaining unit is configured to obtain search information and a media resource, the media resource including a plurality of pieces of media content; the extraction unit is configured to extract a text feature from the search information, and extract a content feature from the media content; the mapping unit is configured to map the content feature by using a feature semantic distribution parameters, to obtain mapped features, distribution of the mapped features following a distribution pattern corresponding to the feature semantic distribution parameters; the recognition unit is configured to perform semantic recognition on the mapped features based on the text feature, to determine semantic types corresponding to the mapped features; the target determining unit is configured to determine target mapped features meeting a relevance condition from different semantic types; and the result determining unit is configured to determine search results for the search information from the media resource according to the target mapped features.

Therefore, in this embodiment of this application, the content features extracted from the media content are mapped by using the feature semantic distribution parameters, so that a feature distance between semantically similar/identical features can be reduced, and a feature distance between semantically different/irrelevant features can be increased. In this way, the mapped features have a better semantic feature expression capability and are easier to distinguish, thereby enabling better semantic recognition and classification by using the mapped features, and improving the accuracy of semantic recognition and classification, to provide accurate search results. Then, the semantic types corresponding to the mapped features are determined according to the text feature extracted from the search information, to select the target mapped features meeting the relevance condition from different semantic types, to return a plurality of diverse search results of different semantic types, to meet diverse search intents of users. Therefore, in this embodiment of this application, with reference to the mapping process based on the feature semantic distribution parameters and the feature filtering process based on different semantic types, accurate and diverse search results can be provided based on search intents of users, thereby meeting user needs and increasing user retention.

An embodiment of this application further provides an electronic device. The electronic device may be a device such as a terminal or a server. The terminal may be a mobile phone, a tablet computer, a smart Bluetooth device, a notebook computer, a personal computer, or the like. The server may be a single server, a server cluster including a plurality of servers, or the like.

In some embodiments, the content search apparatus may alternatively be integrated into a plurality of electronic devices. For example, the content search apparatus may be integrated into a plurality of servers, and the plurality of servers implement the content search method of this application.

In this embodiment, detailed descriptions are provided by using an example in which the electronic device in this embodiment is a server. For example, as shown in FIG. 11, FIG. 11 is a schematic structural diagram of a server according to an embodiment of this application.

Specifically, the server may include components such as a processor 1110 including one or more processing cores, a memory 1120 including one or more computer-readable storage media, a power supply 1130, an input module 1140, and a communication module 1150. A person skilled in the art may understand that the structure of the server shown in FIG. 11 does not constitute a limitation to the server, and the server may include more components or fewer components than those shown in the figure, or some components may be combined, or a different component deployment may be used.

The processor 1110 is a control center of the server, and is connected to various parts of the entire server by using various interfaces and lines. By running or executing a software program and/or module stored in the memory 1120, and invoking data stored in the memory 1120, the processor 1110 performs various functions and data processing of the server. In some embodiments, the processor 1110 may include one or more processing cores. In some embodiments, the processor 1110 may integrate an application processor and a modem. The application processor mainly processes an operating system, a user interface, an application, and the like. The modem mainly processes wireless communication. The foregoing modem may not be integrated into the processor 1110.

The memory 1120 may be configured to store the software program and the module. The processor 1110 runs the software program and the module stored in the memory 1120, to implement various functional applications and data processing. The memory 1120 may mainly include a program storage region and a data storage region. The program storage region may store an operating system, an application required by at least one function (such as a sound playback function and an image display function), and the like. The data storage region may store data created according to use of the server, and the like. In addition, the memory 1120 may include a high speed RAM, and may further include a non-volatile memory, such as at least one magnetic disk storage device, a flash memory, or another volatile solid storage device. Correspondingly, the memory 1120 may further include a memory controller, so that the processor 1110 can access the memory 1120.

The server further includes the power supply 1130 for supplying power to the components. In some embodiments, the power supply 1130 may be logically connected to the processor 1110 by using a power management system, thereby implementing functions such as charging, discharging, and power consumption management by using the power management system. The power supply 1130 may further include one or more of a direct current or alternating current power supply, a re-charging system, a power failure detection circuit, a power supply converter or inverter, a power supply state indicator, and any other components.

The server may further include the input module 1140. The input module 1140 may be configured to receive input digit or character information, and generate a keyboard, mouse, joystick, optical, or track ball signal input related to user setting and function control.

The server may further include the communication module 1150. In some embodiments, the communication module 1150 may include a wireless module. The server may perform short distance wireless transmission by using the wireless module of the communication module 1150, to provide wireless broadband Internet access for a user. For example, the communication module 1150 may be configured to help the user receive and send e-mails, browse a web page, access streaming media, and the like.

Although not shown in the figure, the server may further include a display unit, and the like. Details are not described herein. Specifically, in this embodiment, the processor 1110 of the server may load, according to the following instructions, executable files corresponding to processes of one or more applications into the memory 1120. The processor 1110 runs the applications stored in the memory 1120, to implement various functions as follows:
obtaining search information and a media resource, the media resource including a plurality of pieces of media content; extracting a text feature from the search information, and extracting a content feature from the media content; mapping the content feature to mapped features, a distance between different mapped features being related to semantic relevance between the different mapped features; performing semantic recognition on the mapped features based on the text feature, to determine semantic types corresponding to the mapped features; grouping the mapped features corresponding to the same semantic type into the same combination, and determining target mapped features meeting a relevance condition from different combinations; and determining search results for the search information from the media resource according to the target mapped features.

For a specific implementation of the foregoing operations, reference may be made to the foregoing embodiments. Details are not described herein again.

Therefore, in this embodiment of this application, with reference to the mapping process based on the feature semantic distribution parameters and the feature filtering process based on different semantic types, accurate and diverse search results can be provided based on search intents of users, thereby meeting user needs and increasing user retention.

A person of ordinary skill in the art may understand that all or some operations of various methods in the foregoing embodiments may be implemented through instructions, or may be implemented by instructions by controlling relevant hardware, and the instructions may be stored in a non-transitory computer-readable storage medium and loaded and executed by a processor.

Therefore, an embodiment of this application provides a non-transitory computer-readable storage medium having a plurality of instructions stored therein. The instructions may be loaded by a processor, to perform the operations in any content search method according to the embodiments of this application. For example, the instructions may perform the following operations:
obtaining search information and a media resource, the media resource including a plurality of pieces of media content; extracting a text feature from the search information, and extracting a content feature from the media content; mapping the content feature to mapped features, a distance between different mapped features being related to semantic relevance between the different mapped features; performing semantic recognition on the mapped features based on the text feature, to determine semantic types corresponding to the mapped features; grouping the mapped features corresponding to the same semantic type into the same combination, and determining target mapped features meeting a relevance condition from different combinations; and determining search results for the search information from the media resource according to the target mapped features.

The storage medium may include: a read-only memory (ROM), a random access memory (RAM), a magnetic disk, an optical disc, or the like.

According to an aspect of this application, a computer program product or a computer program is provided. The computer program product or the computer program includes a computer program/instructions, the computer program/instructions being stored in a non-transitory computer-readable storage medium. A processor of an electronic device reads the computer program/instructions from the computer-readable storage medium, and the processor executes the computer program/instructions, to cause the electronic device to perform the methods provided in various implementations according to the foregoing embodiments.

Since the instructions stored in the storage medium can perform the operations in any content search method according to the embodiments of this application, the instructions can implement beneficial effects that can be implemented by any content search method according to the embodiments of this application. For details, refer to the foregoing embodiments, which are not described herein again.

Technical features of the foregoing embodiments may be combined in different manners to form other embodiments. For concise description, not all possible combinations of the technical features in the embodiment are described. However, the combinations of the technical features shall all be considered as falling within the scope described in this specification provided that they do not conflict with each other.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing embodiments only describe several implementations of this application, which are described specifically and in detail, and therefore cannot be construed as a limitation to the patent scope of this application. A person of ordinary skill in the art may further make variations and improvements without departing from the concept of this application, and these shall all fall within the protection scope of this application. Therefore, the protection scope of the patent of this application is subject to the appended claims.

What is claimed is:

1. A content search method performed by a computer device, comprising:
obtaining search information and a media resource, the media resource comprising a plurality of pieces of media content;
extracting a text feature from the search information and a content feature from each of the plurality pieces of media content;
transforming the plurality of content features to multiple mapped features, wherein a distance between a pair of mapped features represents semantic relevance between the pair of mapped features;
performing semantic recognition on the mapped features based on the text feature, to determine semantic types corresponding to the mapped features;
grouping the mapped features corresponding to the same semantic type into a same combination;
determining target mapped features meeting a relevance condition from different combinations based on the distances between mapped features in the different combinations; and
determining search results for the search information from the media resource according to the target mapped features.

2. The method according to claim 1, wherein the extracting a text feature from the search information and a content feature from each of the plurality pieces of media content comprises:
obtaining a pre-trained neural network model, the pre-trained neural network model comprising a text encoder and a content encoder;
extracting the text feature from the search information by using the text encoder; and
extracting the content feature from each of the plurality pieces of media content by using the content encoder.

3. The method according to claim 1, wherein the transforming the plurality of content features to multiple mapped features comprises:
performing feature mapping on the plurality of content features by using preset feature semantic distribution parameters, to obtain the mapped features.

4. The method according to claim 3, wherein the feature semantic distribution parameters comprise non-linear distribution parameters and linear distribution parameters, and the performing feature mapping on the plurality of content features by using a preset feature semantic distribution parameters, to obtain the mapped features comprises:
performing non-linear transformation on the plurality of content features by using the preset non-linear distribution parameters, to obtain intermediate features; and
performing linear transformation on the intermediate features by using the preset linear distribution parameters, to obtain the mapped features.

5. The method according to claim 3, further comprising:
obtaining a training sample set and initial distribution parameters, the training sample set comprising positive samples and negative samples; and
updating the initial distribution parameters through contrastive learning with the positive samples and the negative samples, to obtain the feature semantic distribution parameters.

6. The method according to claim 1, wherein the performing semantic recognition on the mapped features based on the text feature, to determine semantic types corresponding to the mapped features comprises:
combining the text feature and a set formed by the mapped features obtained through mapping, to obtain a feature sequence;
performing global attention processing on any mapped feature based on the feature sequence, to obtain a target feature corresponding to the mapped feature; and
classifying the target feature corresponding to the mapped feature, to obtain a semantic type corresponding to the mapped feature.

7. The method according to claim 1, wherein the determining target mapped features meeting a relevance condition from different combinations based on the distances between mapped features in the different combinations comprises:
determining, in each combination, a ranking number of similarity between each mapped feature and the text feature; and
selecting, from each combination, the mapped features with ranking numbers not exceeding a preset number as the target mapped features.

8. The method according to claim 1, wherein the determining search results for the search information from the media resource according to the target mapped features comprises:
determining target media content corresponding to the target mapped features from the media resource; and
adding the target media content to a search list, to obtain the search results for the search information.

9. The method according to claim 8, wherein the adding the target media content to a search list, to obtain the search results for the search information comprises:
adding the target media content to the search list, to obtain an updated search list; and
ranking the target media content in the updated search list according to search parameters, to obtain the search results for the search information, the search parameters comprising at least one of similarity between the target media content and the search information, visual quality, timestamp, and popularity.

10. A computer device, comprising a processor and a memory, the memory having a plurality of instructions stored therein; and the processor, by executing the instructions from the memory, causing the computer device to perform a content search method including:
obtaining search information and a media resource, the media resource comprising a plurality of pieces of media content;
extracting a text feature from the search information and a content feature from each of the plurality pieces of media content;
transforming the plurality of content features to multiple mapped features, wherein a distance between a pair of mapped features represents semantic relevance between the pair of mapped features;
performing semantic recognition on the mapped features based on the text feature, to determine semantic types corresponding to the mapped features;
grouping the mapped features corresponding to the same semantic type into a same combination;
determining target mapped features meeting a relevance condition from different combinations based on the distances between mapped features in the different combinations; and
determining search results for the search information from the media resource according to the target mapped features.

11. The computer device according to claim 10, wherein the extracting a text feature from the search information and a content feature from each of the plurality pieces of media content comprises:
obtaining a pre-trained neural network model, the pre-trained neural network model comprising a text encoder and a content encoder;
extracting the text feature from the search information by using the text encoder; and
extracting the content feature from each of the plurality pieces of media content by using the content encoder.

12. The computer device according to claim 10, wherein the transforming the plurality of content features to multiple mapped features comprises:
performing feature mapping on the plurality of content features by using preset feature semantic distribution parameters, to obtain the mapped features.

13. The computer device according to claim 12, wherein the feature semantic distribution parameters comprise non-linear distribution parameters and linear distribution parameters, and the performing feature mapping on the plurality of content features by using a preset feature semantic distribution parameters, to obtain the mapped features comprises:
performing non-linear transformation on the plurality of content features by using the preset non-linear distribution parameters, to obtain intermediate features; and
performing linear transformation on the intermediate features by using the preset linear distribution parameters, to obtain the mapped features.

14. The computer device according to claim 10, wherein the method further comprises:
obtaining a training sample set and initial distribution parameters, the training sample set comprising positive samples and negative samples; and
updating the initial distribution parameters through contrastive learning with the positive samples and the negative samples, to obtain the feature semantic distribution parameters.

15. The computer device according to claim 10, wherein the performing semantic recognition on the mapped features based on the text feature, to determine semantic types corresponding to the mapped features comprises:
combining the text feature and a set formed by the mapped features obtained through mapping, to obtain a feature sequence;
performing global attention processing on any mapped feature based on the feature sequence, to obtain a target feature corresponding to the mapped feature; and
classifying the target feature corresponding to the mapped feature, to obtain a semantic type corresponding to the mapped feature.

16. The computer device according to claim 10, wherein the determining target mapped features meeting a relevance condition from different combinations based on the distances between mapped features in the different combinations comprises:
determining, in each combination, a ranking number of similarity between each mapped feature and the text feature; and
selecting, from each combination, the mapped features with ranking numbers not exceeding a preset number as the target mapped features.

17. The computer device according to claim 10, wherein the determining search results for the search information from the media resource according to the target mapped features comprises:
determining target media content corresponding to the target mapped features from the media resource; and
adding the target media content to a search list, to obtain the search results for the search information.

18. The content search method according to claim 10, wherein the adding the target media content to a search list, to obtain the search results for the search information comprises:
adding the target media content to the search list, to obtain an updated search list; and
ranking the target media content in the updated search list according to search parameters, to obtain the search results for the search information, the search parameters comprising at least one of similarity between the target media content and the search information, visual quality, timestamp, and popularity.

19. A non-transitory computer-readable storage medium, having a plurality of instructions stored therein, the instructions, when executed by a processor of a computer device, causing the computer device to perform a content search method including:
obtaining search information and a media resource, the media resource comprising a plurality of pieces of media content;
extracting a text feature from the search information and a content feature from each of the plurality pieces of media content;
transforming the plurality of content features to multiple mapped features, wherein a distance between a pair of mapped features represents semantic relevance between the pair of mapped features;
performing semantic recognition on the mapped features based on the text feature, to determine semantic types corresponding to the mapped features;
grouping the mapped features corresponding to the same semantic type into a same combination;
determining target mapped features meeting a relevance condition from different combinations based on the distances between mapped features in the different combinations; and
determining search results for the search information from the media resource according to the target mapped features.

20. The non-transitory computer-readable storage medium according to claim 19, wherein the extracting a text feature from the search information and a content feature from each of the plurality pieces of media content comprises:
obtaining a pre-trained neural network model, the pre-trained neural network model comprising a text encoder and a content encoder;
extracting the text feature from the search information by using the text encoder; and
extracting the content feature from each of the plurality pieces of media content by using the content encoder.
